(19) United States
(12) Patent Application Publication
(10) Pub. No.: US 2025/0159653 A1
(43) Pub. Date: May 15, 2025

(54) Methods And Apparatuses For Sensing Service Continuity In Integrated Sensing And Communications System

(71) Applicant: MediaTek Singapore Pte. Ltd., Singapore (SG)

(72) Inventors: Wenze Qu, Beijing (CN); Jianwei Zhang, Beijing (CN)

(21) Appl. No.: 18/938,196

(22) Filed: Nov. 5, 2024

(30) Foreign Application Priority Data
Nov. 10, 2023 (WO) PCT/CN2023/131072
Oct. 10, 2024 (CN) 202411411624.2

(51) Int. Cl. H04W 64/00; H04W 24/04

(52) U.S. Cl. CPC H04W 64/006; H04W 24/04

(57) ABSTRACT

Various solutions for sensing service continuity in integrated sensing and communications (ISAC) system are described. An apparatus (e.g., a sensing function (SF)) may select one or more sensing nodes to generate a node list. The apparatus may transmit a configuration of a sensing task to the one or more sensing nodes. The apparatus may receive one or more sensing results of the sensing task from the one or more sensing nodes. The apparatus may update the node list based on the one or more sensing results.

### CROSS REFERENCE TO RELATED PATENT APPLICATION(S)

The present disclosure is part of a non-provisional application claiming the priority benefit of PCT Application No. PCT/CN2023/131072, filed 10 Nov. 2023, and CN application No. 202411411624.2, filed 10 Oct. 2024. The contents of aforementioned applications are herein incorporated by reference in their entirety.

### TECHNICAL FIELD

The present disclosure is generally related to mobile communications and, more particularly, to sensing service continuity in integrated sensing and communications (ISAC) system.

### BACKGROUND

Unless otherwise indicated herein, approaches described in this section are not prior art to the claims listed below and are not admitted as prior art by inclusion in this section.

Mobile communication and radar sensing have been advancing independently for decades. Until recently, the coexistence, cooperation, and joint design of the two systems becomes of interest. Motivation for such topic may include that the use of millimeter waves in 5th generation (5G) and beyond leads to an occupation of adjacent frequency bands, which makes the convergence of the frequency bands used by two systems possible. In addition, with the increasing use of radar sensing in consumer devices and automotive applications, radar systems have entered mass markets. Given that jointly handling communications and sensing on the same architecture or platform would be more cost effective and have lower complexity as compared to two independent platforms, the concept of joint communication and sensing (or called ISAC) is introduced and the beyond 5G (B5G) or 6th Generation (6G) system is envisioned to support sensing service within communication framework.

As the topic is still under study, the design of sensing service continuity for ISAC is not yet defined and it has become an important issue for newly developed wireless communication systems. Therefore, there is a need to provide proper schemes to address this issue.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is proposing schemes, concepts, designs, systems, methods and apparatus pertaining to sensing service continuity in ISAC system. It is believed that the above-described issue would be avoided or otherwise alleviated by implementing one or more of the proposed schemes described herein.

In one aspect, a method may involve an apparatus (e.g., a sensing function (SF)) selecting one or more first sensing nodes to generate a first node list. The method may also involve the apparatus transmitting a configuration of a first sensing task to the one or more first sensing nodes. The method may further involve the apparatus receiving one or more first sensing results of the first sensing task from the one or more first sensing nodes. The method may further involve the apparatus updating the first node list based on the one or more first sensing results.

In one aspect, a method may involve an apparatus (e.g., a sensing node) transmitting information of the sensing node to an SF. The method may also involve the apparatus receiving a configuration of a first sensing task from the SF. The method may further involve the apparatus performing the first sensing task based on the configuration of the first sensing task to obtain a first sensing result of the first sensing task. The method may further involve the apparatus transmitting the first sensing result of the first sensing task to the SF.

In one aspect, an apparatus operating as an SF may comprise a transceiver which, during operation, wirelessly communicates with one or more candidate nodes. The apparatus may also comprise a processor communicatively coupled to the transceiver. The processor, during operation, may perform operations comprising selecting one or more first sensing nodes from the one or more candidate nodes to generate a first node list. The processor may also perform operations comprising transmitting, via the transceiver, a configuration of a first sensing task to the one or more first sensing nodes. The processor may further perform operations comprising receiving, via the transceiver, one or more first sensing results of the first sensing task from the one or more first sensing nodes. The processor may further perform operations comprising updating the first node list based on the one or more first sensing results.

It is noteworthy that, although description provided herein may be in the context of certain radio access technologies (RATs), networks and network topologies such as Long-Term Evolution (LTE), LTE-Advanced, LTE-Advanced Pro, 5G, New Radio (NR), Internet-of-Things (IoT) and Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram depicting example sensing scenarios in accordance with the present disclosure.

FIG. 2 is a diagram depicting a communication environment in which various solutions and schemes in accordance with the present disclosure may be implemented.

FIG. 3 is a diagram depicting an example scenario of sensing node selection, update, and switching for sensing service continuity in accordance with an implementation of the present disclosure.

FIG. 4 is a diagram depicting an example scenario of sensing node selection, update, and switching for sensing service continuity in accordance with an implementation of the present disclosure.

FIG. 5 is a diagram depicting an example scenario of sensing node selection, update, and switching for sensing service continuity in accordance with an implementation of the present disclosure.

FIG. 6 is a diagram depicting an example scenario of sensing node selection, update, and switching for sensing service continuity in accordance with an implementation of the present disclosure.

FIG. 7 is a diagram depicting an example scenario of the procedures for sensing service continuity in accordance with an implementation of the present disclosure.

FIG. 8 is a diagram depicting an example scenario of interactions between SF and sensing nodes during the procedures for sensing service continuity in accordance with an implementation of the present disclosure.

FIG. 9 is a diagram depicting an example scenario of the procedures for sensing service continuity in accordance with an implementation of the present disclosure.

FIG. 10 is a diagram depicting an example scenario of the procedures for sensing service continuity in accordance with an implementation of the present disclosure.

FIG. 11 is a block diagram of an example communication system in accordance with an implementation of the present disclosure.

FIG. 12 is a flowchart of an example process in accordance with an implementation of the present disclosure.

FIG. 13 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to sensing service continuity in ISAC system. According to the present disclosure, a number of possible solutions may be implemented separately or jointly. That is, although these possible solutions may be described below separately, two or more of these possible solutions may be implemented in one combination or another.

The ISAC design is a critical technique for B5G/6G networks, which enables the widely deployed communication systems to be perceptive. In ISAC systems, sensing service continuity is essential since sensing node's capability, locations of sensing node(s) and/or target(s), and channel condition may change during the sensing operations. To ensure sensing service continuity (e.g., to keep the sensing service requirements being met), sensing node selection/update (or referred to herein as node list maintenance) and sensing node switching are required. In view of the above, the present disclosure proposes a number of schemes pertaining to sensing service continuity in ISAC system. According to the schemes of the present disclosure, procedures for sensing service continuity in ISAC are proposed, including node list maintenance, sensing node operations, sensing node switching. It is noteworthy that the proposed design is compatible with sensing mode selection, cooperative sensing and communication cell reselection/handover.

In the present disclosure, sensing tasks may be divided into two types, including a single-task type, and a multi-task type. The single-task type may refer to sensing services that only involve one task, such as target detection (e.g., respiration detection (known person under test exists in a certain area)) or intrusion detection (e.g., illegal unmanned aerial vehicle (UAV) detection in a certain area) with simple parameters estimation, and don't need extra resources for parameters estimation. The multi-task type may refer to sensing services that involve multiple tasks or multiple stages, such as target detection and tracking, or target detection and parameter refinement, with mutual relationships therebetween, and need extra resources (e.g., time/frequency/spatial resource, or sensor) for parameters estimation and new dimension sensing.

A node list may include one or more sensing nodes, such as a base station (BS), user equipment (UE), UE-UE pair, BS-UE pair, and/or BS-BS pair, which perform monostatic sensing, bistatic sensing and/or multi-static sensing. The sensing nodes may be selected from candidate nodes (i.e., sensing nodes are subset of candidate nodes), and candidate nodes may include all nodes with sensing capability in a certain sensing area. Sensing node(s) may include a single node (or node pair) for bistatic sensing, or multiple nodes (or node pairs) for cooperative sensing. One or more node lists may be maintained depending on the sensing task type in use. In one example, one node list may be maintained for the sensing scenario of the single-task type. In another example, two node lists may be maintained for the sensing scenario of a two-task type, wherein each node list is used for a respective task/stage of the sensing scenario.

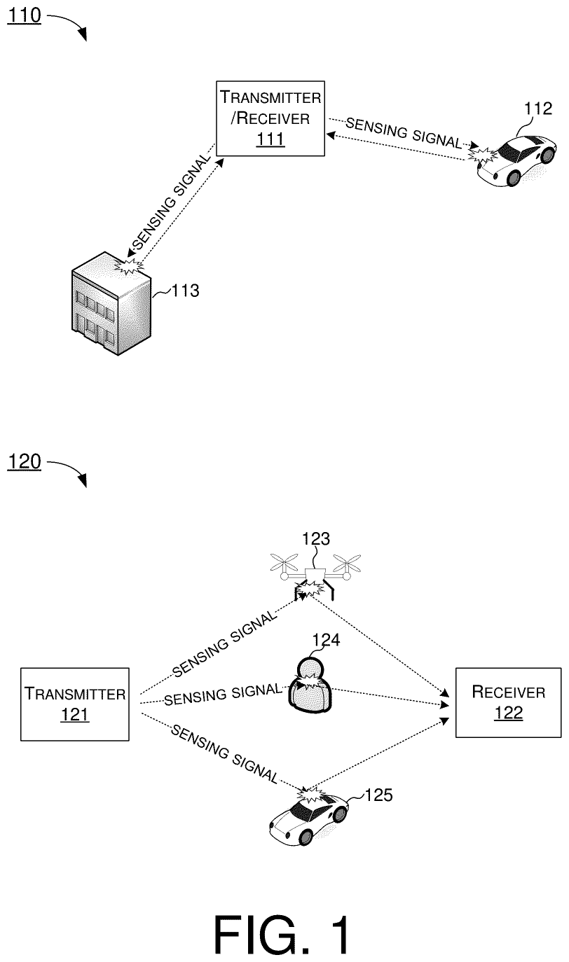

FIG. 1 illustrates example sensing scenarios 110 and 120 in accordance with the present disclosure. Scenario 110 involves a transmitter/receiver 111 and one or more target 112 and 113, wherein the transmitter/receiver 111 is operating as a sensing node which supports monostatic sensing for any of the target 112 (e.g., a car) and the target 113 (e.g., a building). In monostatic sensing, the transmitter unit and receiver unit are generally co-located (e.g., within a single device) (or connected with fiber and act as distributed monostatic system), and thus share complete knowledge of the transmitted signals and the clock. On the other hand, scenario 120 involves a transmitter 121, a receiver 122, and one or more target 123 to 125, wherein the transmitter 121 and the receiver 122 are operating as a pair of sensing nodes which supports bistatic sensing for any of the target 123 (e.g., a UAV), the target 124 (e.g., a pedestrian), and the target 125 (e.g., a car). In bistatic sensing, the transmitter 121 and the receiver 122 are usually at different locations, where the receiver 122 may only have partial knowledge of the transmitted signals and certain synchronization (e.g., clock synchronization) between the transmitter 122 and the receiver 122 may be required. Each of the transmitter/receiver 111, the transmitter 121, and the receiver 122 may be a UE or a BS. In one example, the transmitter 121 may be a BS and the receiver 122 may be a UE, or the transmitter 121 may be a UE and the receiver 122 may be a BS. In another example, the transmitter 121 and the receiver 122 may be two BSs or two UEs. The UE may include a smartphone, a smartwatch, a personal digital assistant, a digital camera, a tablet computer, a laptop computer, a notebook computer, or an IoT/NB-IoT/IIoT apparatus. The BS may include an evolved NodeB (eNB) in 4G LTE, a next-generation NB (gNB) or a transmission and reception point (TRP) in 5G NR, or a B5G/6G NB.

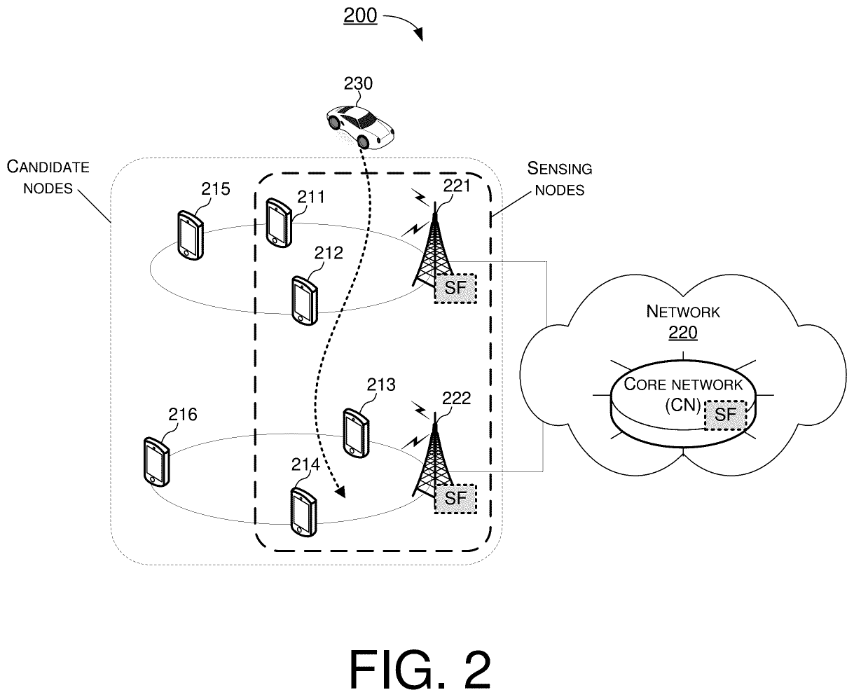

FIG. 2 illustrates an example scenario 200 of a communication environment in which various solutions and schemes in accordance with the present disclosure may be implemented. Scenario 200 involves a plurality of UEs 211-216 in wireless communication with a network 220 (e.g., a wireless network including a core network (CN)) via one or more base stations (BSs) 221-222 (e.g., an eNB, a gNB, or a TRP), wherein the UEs 211-216 and the BSs 221-222 are candidate nodes which may be selected by an SF to operate as sensing nodes for sensing a target 230 (e.g., a car). As shown in FIG. 2, the SF may be a network node or function deployed in the CN or in the BS 221/222, depending on the network architecture. Alternatively, the SF may be deployed in any of the UEs 211-214. The SF is responsible for the following: (i) building/generating and updating node list; (ii) configuring sensing task(s) for sensing nodes; (iii) controlling operation of node switching; (iv) suggesting (if SF is deployed in CN) or determining (if SF is deployed in UE or BS) sensing resources; and (v) collecting and integrating sensing results. The sensing nodes are responsible for the following: (i) transmitting and receiving sensing signal; (ii) processing sensing signal to obtain sensing results; and (iii) reporting sensing results to the SF. In such communication environment as shown in FIG. 2, the UEs 211-216, the BSs 221-222, and the network 220 may implement various schemes pertaining to sensing service continuity in ISAC system in accordance with the present disclosure, as described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

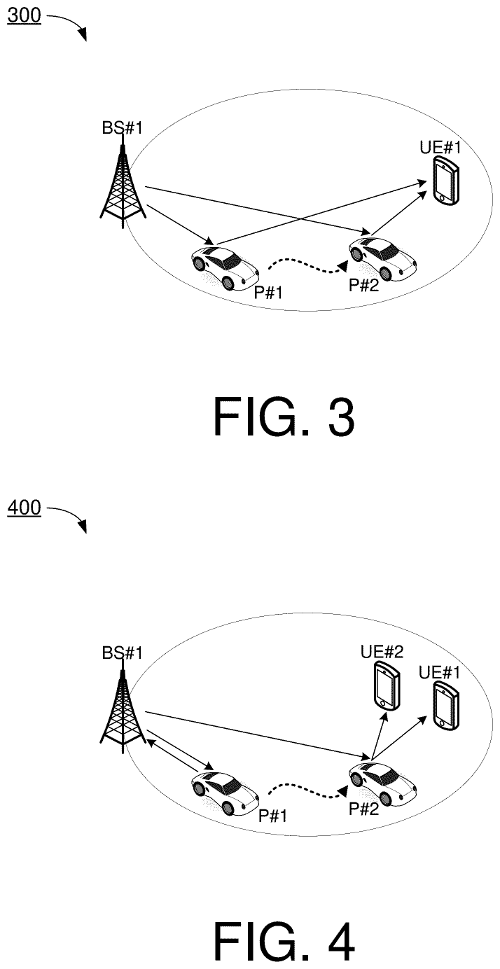

FIG. 3 illustrates an example scenario 300 of sensing node selection, update, and switching for sensing service continuity in accordance with an implementation of the present disclosure. Scenario 300 depicts a target (e.g., a car) moves from one position (denoted as P #1) to another position (denoted as P #2), while the sensing nodes, including a BS (denoted as BS #1) and a UE (denoted as UE #1), and the sensing mode (i.e., bistatic sensing) remain the same as long as the target is still in the coverage of the same BS. In one example, the use cases of scenario 300 may include respiration detection and intrusion detection (e.g., for indoor spaces).

FIG. 4 illustrates an example scenario 400 of sensing node selection, update, and switching for sensing service continuity in accordance with an implementation of the present disclosure. Scenario 400 depicts a target (e.g., a car) moves from one position (denoted as P #1) to another position (denoted as P #2), while the sensing node(s) switches from one BS (denoted as BS #1) to the same BS and one UE (denoted as UE #1 or UE #2) since BS #1 is near P #1 and UE #1/UE #2 are near P #2. During the sensing operations, the sensing mode changes from mono-static sensing to bistatic sensing with cooperative sensing. In one example, the use cases of scenario 400 may include target detection and tracking with cooperative sensing.

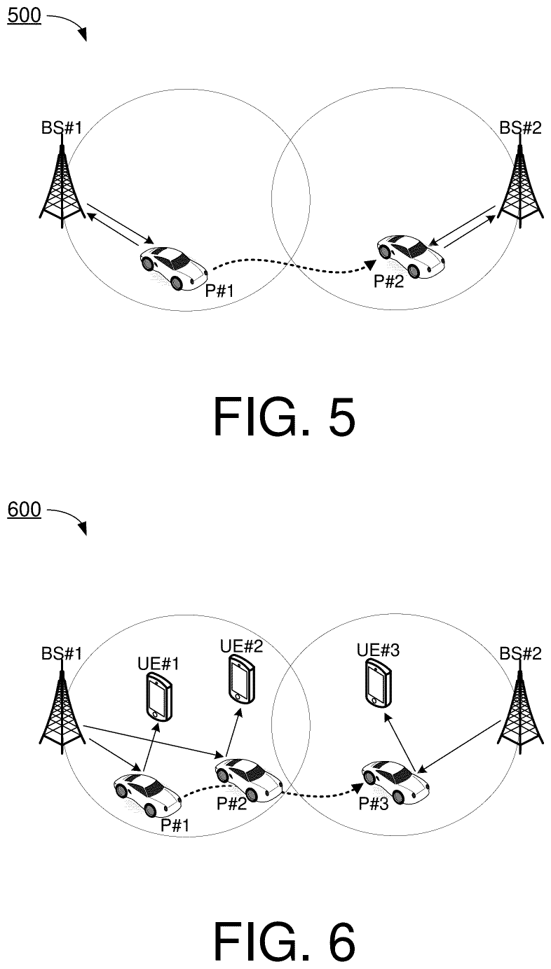

FIG. 5 illustrates an example scenario 500 of sensing node selection, update, and switching for sensing service continuity in accordance with an implementation of the present disclosure. Scenario 500 depicts a target (e.g., a car) moves from one position (denoted as P #1) to another position (denoted as P #2), while the sensing node switches from one BS (denoted as BS #1) to another BS (denoted as BS #2) since P #1 is within the coverage of BS #1 and P #2 is within the coverage of BS #2. During the sensing operations, the sensing mode does not change, i.e., remains as mono-static sensing. In one example, the use cases of scenario 500 may include target detection and tracking with BS-based mono-static sensing.

FIG. 6 illustrates an example scenario 600 of sensing node selection, update, and switching for sensing service continuity in accordance with an implementation of the present disclosure. Scenario 600 depicts a target (e.g., a car) moves from P #1 to P #2 and then from P #2 to P #3, while the sensing nodes switch from the node pair {BS #1, UE #1} to {BS #1, UE #2} and then from the node pair {BS #1, UE #2} to {BS #2, UE #3}. During the sensing operations, the sensing mode does not change, i.e., remains as bistatic sensing, due to the fact that UE #1 to UE #3 are near P #1 to P #3, respectively, UE #1 and UE #2 are within the coverage of BS #1, and UE #3 is within the coverage of BS #2. In one example, the use cases of scenario 600 may include target detection and tracking with BS-to-UE bistatic sensing.

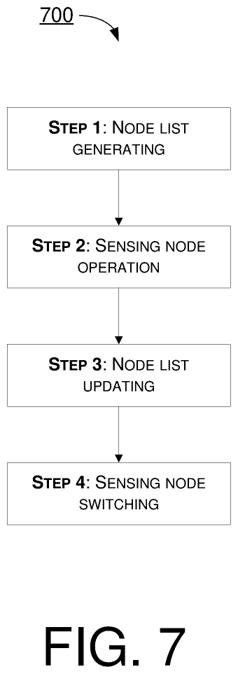

FIG. 7 illustrates an example scenario 700 of the procedures for sensing service continuity in accordance with an implementation of the present disclosure. As shown in FIG. 7, the procedures may consist of four steps, including: (i) node list generating; (ii) sensing node operation; (iii) node list updating; and (iv) sensing node switching. In one example, for the sensing scenarios of single-task type, only one set of the procedural steps corresponding to the single node list may be required. In another example, for the sensing scenarios of two-task type, two sets of the procedural steps, each corresponding to a respective node list, may be required, where the steps in the second set may have relationships with the steps in the first set. Each of the steps will be described with more details later in the present disclosure.

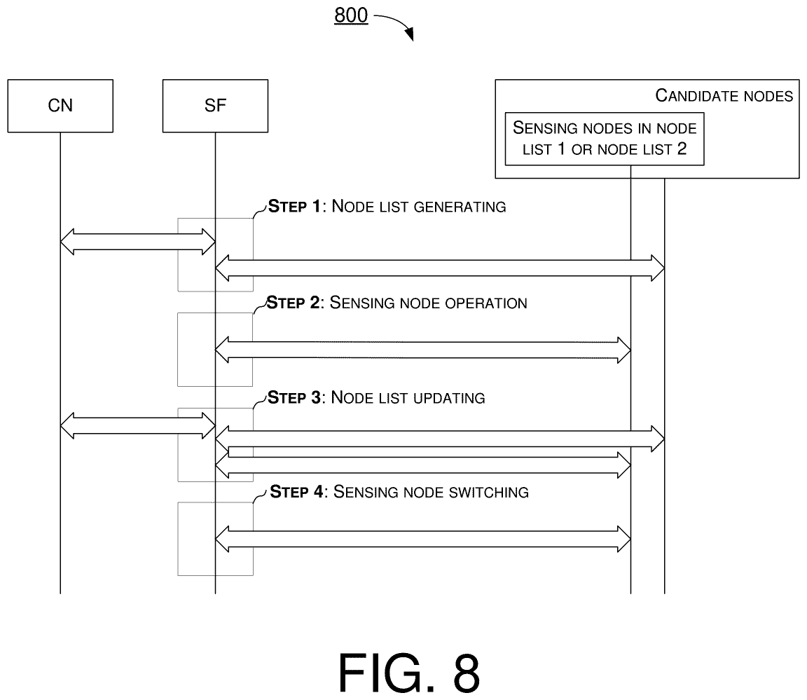

FIG. 8 illustrates an example scenario 800 of interactions between SF and sensing nodes during the procedures for sensing service continuity in accordance with an implementation of the present disclosure. Step 1 may include two operations, such as collecting information of the candidate nodes, and performing sensing node selection to generate a node list. The SF may periodically or aperiodically trigger each candidate node (for single-task type) or each sensing node in node list 1 (for two-task type) to report its sensing related information, including sensing capability information, location information (i.e., candidate node's position), and sensing signal quality information. Alternatively, for two-task type, each sensing node in node list 1 may periodically report its sensing related information to the SF. Specifically, the sensing related information may include at least one of the following information: (i) whether it supports sensing or not; (ii) the sensing capability such as supported sensing mode, covered sensing area, sensing quantities, accuracy, and resolution, etc.; (iii) candidate node's position such as global positioning system (GPS) information, or positioning related reporting information and transmission signal; (iv) signal quality such as downlink (DL) communication link quality (e.g., received signal strength indication (RSSI), reference signal receiving power (RSRP), reference signal received quality (RSRQ), or signal-to-noise ratio (SNR)) measured by UE. Additionally, or optionally, the SF may collect candidate information from the CN (e.g., collect UE's position information from the location management function (LMF)). Based on the collected node information and the sensing service/task requirements, the SF may select one or more sensing nodes from the candidate nodes to generate the node list 1, or select one or more sensing nodes from the sensing nodes in node list 1 to generate the node list 2. The criteria of selection may include whether the selected node's sensing capability, location, and sensing accuracy can match with sensing service/task requirements. For example, the criteria of selection for node list 2 generating may include at least one of the following: (i) the selected node can detect the target; (ii) the selected node's sensing quality is good (e.g., the sensing quality is above a threshold); (iii) the distance from the selected node to the target is below a threshold; and (iv) the selected node supports high accuracy sensing or tracking.

Step 2 may include four operations, such as sensing node configuration, sensing operations, sensing results reporting, and sensing results integration. For sensing node configuration, the SF may trigger every node (or node-pair) in node list 1 (for single-task type) or in node list 2 (for two-task type) to start performing the sensing task. The SF may provide the configuration of the sensing task, including task contents, suggested sensing resource, and requirements of the sensing task. Since the sensing nodes in node list 2 are also belong to node list 1, they may have to perform both the sensing task of node list 1 (e.g., target detection) and the sensing task of node list 2 (e.g., target tracking or parameter refinement). For sensing operations, the sensing node (or node-pair) may determine the sensing resource configuration (e.g., time, frequency and spatial domain pattern, time domain duration, period, and power of the sensing signals) based on the configuration provided by the SF, and then start performing sensing operations, including signal transmission/reception and sensing result calculation (e.g., by using sensing algorithms such as two dimensional-Fast Fourier Transform (2D-FFT), multiple signal classification (MUSIC), iterative adaptive approach (IAA), etc.). The sensing operations may be performed periodic, semi-persistent, or aperiodic, depending on the sensing task requirements. For sensing results reporting, each sensing node (or node-pair) may report its sensing result to the SF. If the sensing mode is bistatic or multi-static sensing, it is the Rx node to report the sensing result. The sensing result may include the required sensing measurement quantities, and corresponding sensing quality may be used to determine the reliability of sensing result. For sensing results integration, the SF may integrate all sensing results to obtain the information of the target(s). If there are multiple targets, the SF may apply the target clustering algorithm to match targets with the sensing result from each sensing node.

Step 3 may include two operations, such as collecting updated information of the candidate nodes, and node list updating. For collecting updated information of the candidate nodes, the SF may collect the updated information of all candidate nodes (for single-task type) or all sensing nodes in node list 1 (for two-task type). The updated information may be periodically reported by these nodes, or aperiodically reported by the trigger from the SF or from these nodes themselves (e.g., when sensing capability has changed). Additionally, or optionally, the SF may also collect some information from the sensing results (e.g., corresponding quality information of sensing nodes in node list 1 or node list 2), wherein these information may include whether it can detect the target, and whether the quality of sensing result is good or not). For node list updating, the SF may update node list 1 or node list 2 based on the updated information. Specifically, the SF may select new node(s) (or node-pair(s)) from candidate nodes to add into node list 1 or 2, and/or remove original node(s) (or node-pairs) from node list 1 or 2. In one example, the nodes that have become closer to the target and/or the nodes with sensing capabilities that have become better may be added into node list 1, while the nodes with sensing capabilities that have become worse and/or the nodes that have poor sensing quality may be removed from node list 1. In another example, the nodes that have become closer to the target and can detect the target with better sensing quality may be added into node list 2, while the nodes with sensing capabilities that have become worse and/or the nodes that have poor sensing quality may be removed from node list 2.

Step 4 may include two operations, such as stopping operation of removed node, and starting operation of new node. For stopping operation of removed node, the SF may send an indication of stopping the sensing operation of the sensing task to the removed nodes. Before the node (or node-pair) stopping the sensing operation, it may report some information, such as the sensing resource configuration, and the latest sensing result, to the SF to assist with new node's configuration. If the node is removed from node list 2, the removed node may still need to perform the sensing task of node list 1 after stopping the sensing task of node list 2. For starting operation of new node, the SF may trigger the new node(s) (or node pair(s)) to start sensing node configuration, sensing operations, and sensing results reporting similar to step 2, but the difference is that there are some information (e.g., target's information, and sensing resource configuration) from the original nodes, which may be used as reference for sensing configuration operation. Additionally, or optionally, for the sensing nodes that were originally in node list 1, their sensing configurations such as sensing signal resource, and time domain period may be adjusted based on the previous sensing results. If the new node is added to node list 2, the new node may need to perform both the sensing task of node list 1 and the sensing task of node list 2.

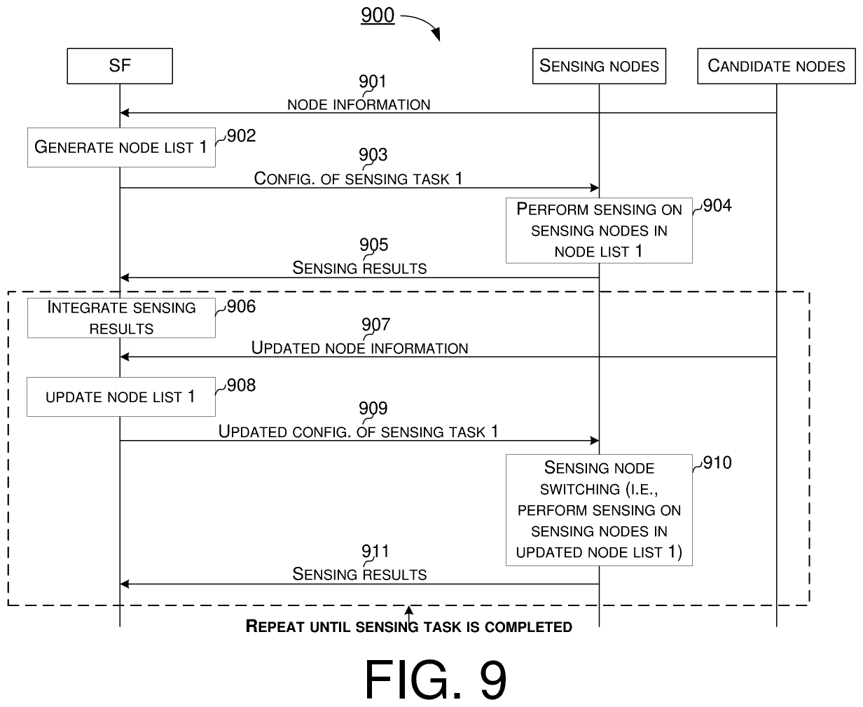

FIG. 9 illustrates an example scenario 900 of the procedures for sensing service continuity in accordance with an implementation of the present disclosure. Scenario 900 depicts a single-task type sensing scenario, such as the use case of target detection/tracking or intrusion detection with simple parameters estimation (which may not need extra resources for parameters estimation). In step 901, all candidate nodes report their node information, including sensing capability information, location information, and sensing signal quality information, etc. For example, the reported node information of each candidate node may include at least one of the following: (i) whether it supports sensing or not; (ii) its sensing capability (e.g., sensing mode, covered sensing area, sensing accuracy, etc.); (iii) its position (e.g., leverage positioning information) if supporting; and (iv) the sensing signal quality (e.g., UE DL signal quality such as RSSI, RSRP, RSRQ, SNR, etc.). In step 902, based on the reported node information of all candidate nodes, the SF generates node list 1. In step 903, the SF configures the sensing task to the sensing nodes in node list 1, wherein the configuration of the sensing task may include (suggested) sensing resource allocation for each sensing node. It should be noted that the SF can only suggest sensing resource if the SF is implemented in CN; otherwise, if the SF is implemented in BS or UE, it can determine the sensing resource to apply.

In step 904, based on the configuration provided by the SF, each sensing node starts related sensing operations of the sensing task. The sensing operations may include Tx and Rx sensing nodes transmit and receive sensing signal, sensing signal processing and sensing result calculation, etc. The sensing operations may be performed periodically, semi-periodically, or aperiodically, depending on the sensing use case. In step 905, each sensing node reports its sensing result to the SF. In step 906, the SF collects and integrates the sensing results. The integration may include different levels of integration, such as integration of sensing results, integration of sensing signal or intermediate results. In step 907, all candidate nodes update their node information to the SF, similar to step 901. The node information update may be periodic or event-triggered (e.g., current sensing nodes' sensing signal quality is not good, or there isn't enough sensing nodes for current sensing task). In step 908, the SF updates node list 1 based on the sensing results and the updated node information. In one example, the node list update may be required in the case where some original sensing nodes in the sensing area are no longer suitable for sensing (e.g., because of the limitation of loading) and some newcomer nodes can be chosen as new sensing nodes. In another example, the node list update may be required in the case where some original sensing nodes are getting further away from the target as the target moves, and some candidate nodes become closes to the target. In step 909, the SF reconfigures the sensing task and allocates/indicates sensing resource to the sensing nodes in the updated node list 1. For example, the sensing period in the configuration may be adjusted according to sensing results (e.g., if sensing signal quality of the sensing result is good, a longer sensing period can be configured).

In step 910, sensing node switching is performed based on the updated node list. Specifically, some candidate nodes that become sensing nodes may start sensing operations based on the updated configuration, while some original sensing nodes that are removed from the node list may stop sensing operations. In step 911, each sensing node reports its sensing result to the SF. After that, steps 906-911 may be repeated until the sensing task is completed.

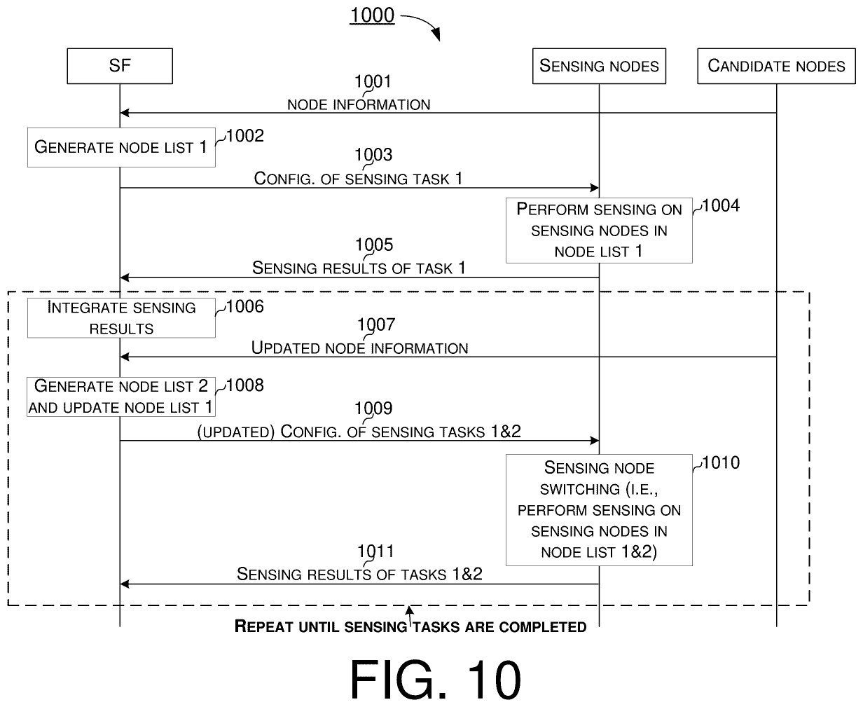

FIG. 10 illustrates an example scenario 1000 of the procedures for sensing service continuity in accordance with an implementation of the present disclosure. Scenario 1000 depicts a two-task type sensing scenario, such as the use case of target detection and tracking with complex parameters estimation or with new dimension sensing, which needs extra resources (e.g., time/frequency/spatial resource, or sensor) for parameters estimation and new dimension sensing. Steps 1001-1007 are similar to steps 901-907, and thus, the detailed description is omitted herein for brevity. In step 1008, based on the sensing results and the updated node information, the SF generates node list 2 for sensing task 2 (i.e., target tracking) and updates node list 1 for sensing task 1 (i.e., target detection). Factors involved in sensing node selection for node list 2 may include the sensing results of the sensing nodes in node list 1, target location, and node position, etc. Factors involved in the update of node list 1 may include sensing nodes status (suitable for sensing or not), sensing nodes position, target location, sensing results of sensing nodes in node list 1, and sensing results of sensing nodes in node list 2 (if available). In step 1009, the SF configures sensing task 2, reconfigures sensing task 1, and allocates/indicates sensing resource to the sensing nodes in node list 2 and updated node list 1. For example, the sensing period in the updated configuration may be adjusted according to sensing results (e.g., if sensing signal quality of the sensing result is good, a longer sensing period can be configured). In step 1010, sensing node switching is performed based on node lists 1 and 2. In step 1011, each sensing node reports its sensing result to the SF. After that, steps 1006-1011 may be repeated until the sensing tasks are completed.

### Illustrative Implementations

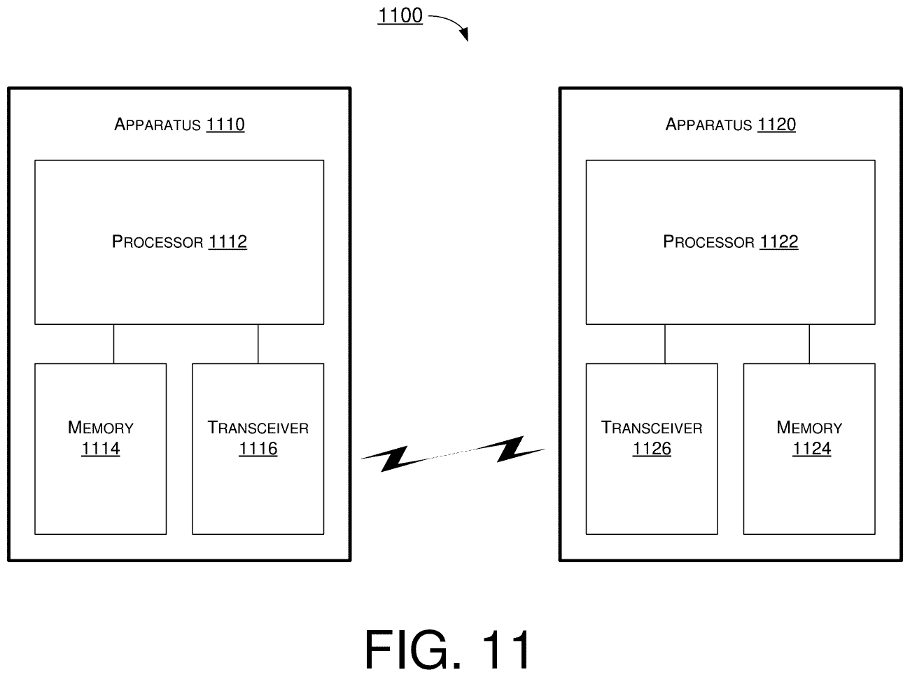

FIG. 11 illustrates an example communication system 1100 having two example apparatuses 1110 and 1120 in accordance with an implementation of the present disclosure. Each of apparatus 1110 and apparatus 1120 may perform various functions to implement schemes, techniques, processes and methods described herein pertaining to wireless sensing in ISAC system, including scenarios/schemes described above as well as processes 1200 and 1300 described below.

Apparatus 1110 may be a part of an electronic apparatus operating as sensing node, which may be a UE or BS with sensing capability. The UE may be a portable or mobile apparatus, a wearable apparatus, a wireless communication apparatus or a computing apparatus (e.g., mounted on vehicles). For instance, apparatus 1110 may be implemented in a smartphone, a smartwatch, a personal digital assistant, a digital camera, or a computing equipment such as a tablet computer, a laptop computer or a notebook computer. The UE may also be a part of a machine type apparatus, which may be an IoT, NB-IoT, or IIoT apparatus such as an immobile or a stationary apparatus, a home apparatus, a wire communication apparatus or a computing apparatus. For instance, apparatus 1110 may be implemented in a smart thermostat, a smart fridge, a smart door lock, a wireless speaker or a home control center. Alternatively, apparatus 1110 may be a network node such as a BS, a small cell, a router or a gateway. For instance, apparatus 1110 may be implemented in an eNB in an LTE, LTE-Advanced or LTE-Advanced Pro network or in a gNB in a 5G, NR, IoT, NB-IoT or IIoT network. Furthermore, apparatus 1110 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Apparatus 1110 may include at least some of those components shown in FIG. 11 such as a processor 1112, for example. Apparatus 1110 may further include one or more other components not pertinent to the proposed scheme of the present disclosure (e.g., internal power supply, display device and/or user interface device), and, thus, such component(s) of apparatus 1110 are neither shown in FIG. 11 nor described below in the interest of simplicity and brevity.

Apparatus 1120 may be a part of an electronic apparatus operating as an SF, which may be implemented in a UE, a BS, or a network node in the CN of a wireless network. Furthermore, apparatus 1120 may be implemented in the form of one or more IC chips such as, for example and without limitation, one or more single-core processors, one or more multi-core processors, one or more RISC processors, or one or more CISC processors. Apparatus 1120 may include at least some of those components shown in FIG. 11 such as a processor 1122, for example. Apparatus 1120 may further include one or more other components not pertinent to the proposed scheme of the present disclosure (e.g., internal power supply, display device and/or user interface device), and, thus, such component(s) of apparatus 1120 are neither shown in FIG. 11 nor described below in the interest of simplicity and brevity.

In one aspect, each of processor 1112 and processor 1122 may be implemented in the form of one or more single-core processors, one or more multi-core processors, or one or more CISC processors. That is, even though a singular term “a processor” is used herein to refer to processor 1112 and processor 1122, each of processor 1112 and processor 1122 may include multiple processors in some implementations and a single processor in other implementations in accordance with the present disclosure. In another aspect, each of processor 1112 and processor 1122 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1112 and processor 1122 is a special-purpose machine specifically designed, arranged and configured to perform specific tasks including the procedures for sensing service continuity in ISAC system in accordance with various implementations of the present disclosure.

In some implementations, apparatus 1110 may also include a transceiver 1116 coupled to processor 1112 and capable of wirelessly transmitting and receiving communication and sensing signals. In some implementations, transceiver 1116 may be capable of wirelessly communicating with different types of UEs/BSs of different RATs. In some implementations, transceiver 1116 may be equipped with a plurality of antenna ports (not shown) such as, for example, four antenna ports. That is, transceiver 1116 may be equipped with multiple transmit antennas and multiple receive antennas for multiple-input multiple-output (MIMO) wireless communications. In some implementations, apparatus 1120 may also include a transceiver 1126 coupled to processor 1122 and capable of communicating with and coordinating sensing nodes such as UEs and BSs. In some implementations, transceiver 1126 may be equipped with a plurality of antenna ports (not shown) such as, for example, four antenna ports. That is, transceiver 1126 may be equipped with multiple transmit antennas and multiple receive antennas for MIMO wireless communications. In some implementations, transceiver 1126 may be equipped with a wired network interface such as fiber optic cable for communicating with other network nodes. Accordingly, apparatus 1110 and apparatus 1120 may communicate with each other directly or indirectly (depending on the network architecture) via transceiver 1116 and transceiver 1126, respectively.

In some implementations, apparatus 1110 may further include a memory 1114 coupled to processor 1112 and capable of being accessed by processor 1112 and storing data therein. In some implementations, apparatus 1120 may further include a memory 1124 coupled to processor 1122 and capable of being accessed by processor 1122 and storing data therein. Each of memory 1114 and memory 1124 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1114 and memory 1124 may include a type of read-only memory (ROM) such as mask ROM, programmable ROM (PROM), erasable programmable ROM (EPROM) and/or electrically erasable programmable ROM (EEPROM). Alternatively, or additionally, each of memory 1114 and memory 1124 may include a type of non-volatile random-access memory (NVRAM) such as flash memory, solid-state memory, ferroelectric RAM (FeRAM), magnetoresistive RAM (MRAM) and/or phase-change memory.

Each of apparatus 1110 and apparatus 1120 may be a communication entity capable of communicating with each other using various proposed schemes in accordance with the present disclosure. For illustrative purposes and without limitation, a description of operations, functionalities, and capabilities of apparatus 1110, implemented in or operating as a sensing node, and apparatus 1120, implemented in or operating as an SF, is provided below with processes 1200 and 1300.

### Illustrative Processes

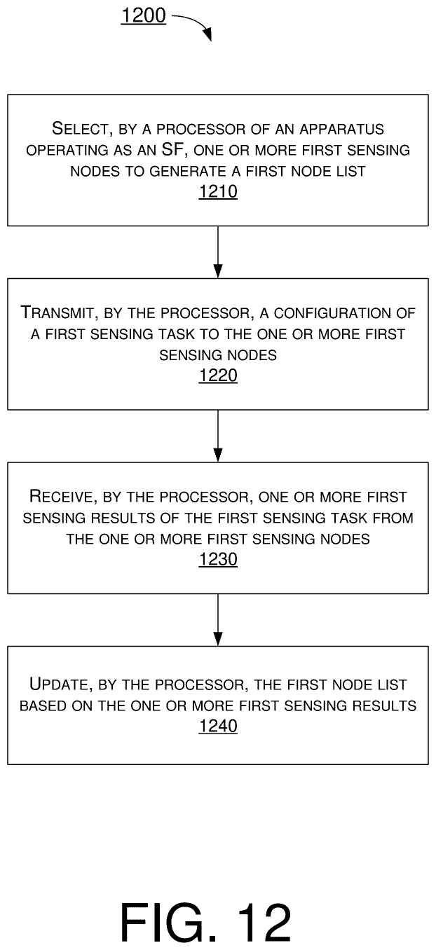

FIG. 12 illustrates an example process 1200 in accordance with an implementation of the present disclosure. Process 1200 may be an example implementation of above scenarios/schemes, whether partially or completely, with respect to sensing service continuity in ISAC system. Process 1200 may represent an aspect of implementation of features of apparatus 1120. Process 1200 may include one or more operations, actions, or functions as illustrated by one or more of blocks 1210 to 1240. Although illustrated as discrete blocks, various blocks of process 1200 may be divided into additional blocks, combined into fewer blocks, or eliminated, depending on the desired implementation. Moreover, the blocks of process 1200 may be executed in the order shown in FIG. 12 or, alternatively, in a different order. Process 1200 may be implemented by apparatus 1120 or any suitable network node capable of operating as an SF. Solely for illustrative purposes and without limitation, process 1200 is described below in the context of apparatus 1120 as an SF. Process 1200 may begin at block 1210.

At 1210, process 1200 may involve processor 1122 of apparatus 1120 selecting one or more first sensing nodes to generate a first node list. Process 1200 may proceed from 1210 to 1220.

At 1220, process 1200 may involve processor 1122 transmitting, via transceiver 1126, a configuration of a first sensing task to the one or more first sensing nodes. Process 1200 may proceed from 1220 to 1230.

At 1230, process 1200 may involve processor 1122 receiving, via transceiver 1126, one or more first sensing results of the first sensing task from the one or more first sensing nodes. Process 1200 may proceed from 1230 to 1240.

At 1240, process 1200 may involve processor 1122 updating the first node list based on the one or more first sensing results.

In some implementations, process 1200 may further involve processor 1122 receiving, via transceiver 1126, information of one or more candidate nodes from the one or more candidate nodes or from a core network, wherein the one or more first sensing nodes are selected from the one or more candidate nodes based on the information of the one or more candidate nodes and requirements of the first sensing task.

In some implementations, the information of the one or more candidate nodes may include at least one of the following: (i) sensing capability information; (ii) location information; and (iii) sensing signal quality information.

In some implementations, process 1200 may further involve processor 1122 integrating the one or more first sensing results to obtain first information of one or more targets of the first sensing task.

In some implementations, process 1200 may further involve processor 1122 receiving, via transceiver 1126, updated information of the one or more candidate nodes from the one or more candidate nodes, wherein the first node list is updated based on the updated information and the one or more first sensing results.

In some implementations, the updating of the first node list may include at least one of the following: (i) removing at least one of the one or more first sensing nodes from the first node list; and (ii) adding at least one new sensing node to the first node list.

In some implementations, process 1200 may further involve processor 1122 transmitting, via transceiver 1126, an indication of stopping the first sensing task to the at least one removed sensing node. Alternatively, process 1200 may further involve processor 1122 transmitting, via transceiver 1126, an updated configuration of the first sensing task to all sensing nodes in the updated first node list, wherein the updated configuration is determined based on at least one of the configuration of the first sensing task and the one or more first sensing results.

In some implementations, process 1200 may further involve processor 1122 selecting one or more second sensing nodes from the updated first node list to generate a second node list, and transmitting, via transceiver 1126, a configuration of a second sensing task to the one or more second sensing nodes. Additionally, process 1200 may further involve processor 1122 receiving, via transceiver 1126, one or more second sensing results of the second sensing task from the one or more second sensing nodes, and updating the second node list based on the one or more second sensing results.

In some implementations, the updating of the second node list may include at least one of the following: (i) removing at least one of the one or more second sensing nodes from the second node list; and (ii) adding at least one new sensing node to the second node list.

In some implementations, process 1200 may further involve processor 1122 transmitting, via transceiver 1126, an indication of stopping the second sensing task to the at least one removed sensing node. Alternatively, process 1200 may further involve processor 1122 transmitting, via transceiver 1126, an updated configuration of the second sensing task to the at least one added sensing node, wherein the updated configuration is determined based on at least one of the configuration of the second sensing task and the one or more second sensing results.

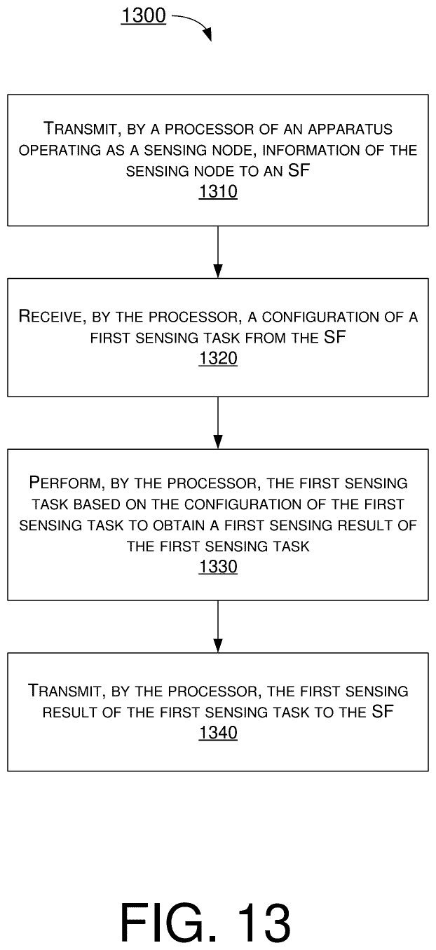

FIG. 13 illustrates an example process 1300 in accordance with an implementation of the present disclosure. Process 1300 may be an example implementation of above scenarios/schemes, whether partially or completely, with respect to sensing service continuity in ISAC system. Process 1300 may represent an aspect of implementation of features of apparatus 1110. Process 1300 may include one or more operations, actions, or functions as illustrated by one or more of blocks 1310 to 1340. Although illustrated as discrete blocks, various blocks of process 1300 may be divided into additional blocks, combined into fewer blocks, or eliminated, depending on the desired implementation. Moreover, the blocks of process 1300 may be executed in the order shown in FIG. 13 or, alternatively, in a different order. Process 1300 may be implemented by apparatus 1110 or any suitable sensing node. Solely for illustrative purposes and without limitation, process 1300 is described below in the context of apparatus 1110 as a sensing node and apparatus 1120 as an SF. Process 1300 may begin at block 1310.

At 1310, process 1300 may involve processor 1112 of apparatus 1110 transmitting, via transceiver 1116, information of apparatus 1110 to apparatus 1120. Process 1300 may proceed from 1310 to 1320.

At 1320, process 1300 may involve processor 1112 receiving, via transceiver 1116, a configuration of a first sensing task from apparatus 1120. Process 1300 may proceed from 1320 to 1330.

At 1330, process 1300 may involve processor 1112 performing the first sensing task based on the configuration of the first sensing task to obtain a first sensing result of the first sensing task. Process 1300 may proceed from 1330 to 1340.

At 1340, process 1300 may involve processor 1112 transmitting, via transceiver 1116, the first sensing result of the first sensing task to apparatus 1120.

In some implementations, the information of apparatus 1110 may include at least one of the following: (i) sensing capability information; (ii) location information; and (iii) sensing signal quality information.

In some implementations, the configuration of the first sensing task may include at least one of the following: (i) time and frequency resources; and (ii) requirements of the first sensing task.

In some implementations, the performing of the first sensing task may include: transmitting a sensing signal based on the configuration of the first sensing task in an event that apparatus 1110 is a transmitting node; or receiving the sensing signal based on the configuration of the first sensing task and performing a sensing of a target based on the sensing signal in an event that apparatus 1110 is a receiving node.

In some implementations, process 1300 may further involve processor 1112 receiving, via transceiver 1116, an indication of stopping the first sensing task from apparatus 1120. Alternatively, process 1300 may further involve processor 1112 receiving, via transceiver 1116, an updated configuration of the first sensing task from apparatus 1120 and performing the first sensing task based on the updated configuration of the first sensing task, wherein the updated configuration of the first sensing task is determined based on at least one of the configuration of the first sensing task and the first sensing result.

In some implementations, process 1300 may further involve processor 1112 transmitting, via transceiver 1116, at least one of a sensing resource configuration and an updated sensing result of the first sensing task to apparatus 1120 responsive to receiving the indication. Additionally, process 1300 may further involve processor 1112 stopping performing the first sensing task based on the indication.

In some implementations, process 1300 may further involve processor 1112 transmitting, via transceiver 1116, updated information of the sensing node to apparatus 1120, and receiving, via transceiver 1116, a configuration of a second sensing task from apparatus 1120. Additionally, process 1300 may further involve processor 1112 performing the second sensing task based on the configuration of the second sensing task to obtain a second sensing result of the second sensing task, and transmitting, via transceiver 1116, the second sensing result of the second sensing task to apparatus 1120.

In some implementations, process 1300 may further involve processor 1112 receiving, via transceiver 1116, an indication of stopping the second sensing task from apparatus 1120. Alternatively, process 1300 may further involve processor 1112 receiving, via transceiver 1116, an updated configuration of the second sensing task from apparatus 1120 and performing the second sensing task based on the updated configuration of the second sensing task, wherein the updated configuration of the second sensing task is determined based on at least one of the configuration of the second sensing task and the second sensing result.

In some implementations, process 1300 may further involve processor 1112 transmitting, via transceiver 1116, at least one of a sensing resource configuration and an updated sensing result of the second sensing task to apparatus 1120 responsive to receiving the indication. Additionally, process 1300 may further involve processor 1112 stopping performing the second sensing task based on the indication.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
selecting, by a processor of an apparatus operating as a sensing function (SF), one or more first sensing nodes to generate a first node list;
transmitting, by the processor, a configuration of a first sensing task to the one or more first sensing nodes;
receiving, by the processor, one or more first sensing results of the first sensing task from the one or more first sensing nodes; and
updating, by the processor, the first node list based on the one or more first sensing results.

2. The method of claim 1, further comprising:
receiving, by the processor, information of one or more candidate nodes from the one or more candidate nodes or from a core network, wherein the one or more first sensing nodes are selected from the one or more candidate nodes based on the information of the one or more candidate nodes and requirements of the first sensing task.

3. The method of claim 1, wherein the information of the one or more candidate nodes comprises at least one of the following:
sensing capability information;
location information; and
sensing signal quality information.

4. The method of claim 1, further comprising:
integrating, by the processor, the one or more first sensing results to obtain first information of one or more targets of the first sensing task.

5. The method of claim 2, further comprising:
receiving, by the processor, updated information of the one or more candidate nodes from the one or more candidate nodes, wherein the first node list is updated based on the updated information and the one or more first sensing results.

6. The method of claim 1, wherein the updating of the first node list comprises at least one of the following:
removing at least one of the one or more first sensing nodes from the first node list; and
adding at least one new sensing node to the first node list.

7. The method of claim 1, further comprising:
transmitting, by the processor, an indication of stopping the first sensing task to the at least one removed sensing node; or
transmitting, by the processor, an updated configuration of the first sensing task to all sensing nodes in the updated first node list, wherein the updated configuration is determined based on at least one of the configuration of the first sensing task and the one or more first sensing results.

8. The method of claim 1, further comprising:
selecting, by the processor, one or more second sensing nodes from the updated first node list to generate a second node list;
transmitting, by the processor, a configuration of a second sensing task to the one or more second sensing nodes;
receiving, by the processor, one or more second sensing results of the second sensing task from the one or more second sensing nodes; and
updating, by the processor, the second node list based on the one or more second sensing results.

9. The method of claim 8, wherein the updating of the second node list comprises at least one of the following:
removing at least one of the one or more second sensing nodes from the second node list; and
adding at least one new sensing node to the second node list.

10. The method of claim 9, further comprising:
transmitting, by the processor, an indication of stopping the second sensing task to the at least one removed sensing node; or
transmitting, by the processor, an updated configuration of the second sensing task to the at least one added sensing node, wherein the updated configuration is determined based on at least one of the configuration of the second sensing task and the one or more second sensing results.

11. A method, comprising:
transmitting, by a processor of an apparatus operating as a sensing node, information of the sensing node to a sensing function (SF);
receiving, by the processor, a configuration of a first sensing task from the SF;
performing, by the processor, the first sensing task based on the configuration of the first sensing task to obtain a first sensing result of the first sensing task; and
transmitting, by the processor, the first sensing result of the first sensing task to the SF.

12. The method of claim 11, wherein the information of the sensing node comprises at least one of the following:
sensing capability information;
location information; and
sensing signal quality information.

13. The method of claim 11, wherein the configuration of the first sensing task comprises at least one of the following:
time and frequency resources; and
requirements of the first sensing task.

14. The method of claim 11, wherein the performing of the first sensing task comprises:
transmitting a sensing signal based on the configuration of the first sensing task in an event that the sensing node is a transmitting node; or
receiving the sensing signal based on the configuration of the first sensing task and performing a sensing of a target based on the sensing signal in an event that the sensing node is a receiving node.

15. The method of claim 11, further comprising:
receiving, by the processor, an indication of stopping the first sensing task from the SF; or
receiving, by the processor, an updated configuration of the first sensing task from the SF and performing the first sensing task based on the updated configuration of the first sensing task, wherein the updated configuration of the first sensing task is determined based on at least one of the configuration of the first sensing task and the first sensing result.

16. The method of claim 15, further comprising:
transmitting, by the processor, at least one of a sensing resource configuration and an updated sensing result of the first sensing task to the SF responsive to receiving the indication; and
stopping, by the processor, performing the first sensing task based on the indication.

17. The method of claim 11, further comprising:
transmitting, by the processor, updated information of the sensing node to the SF;
receiving, by the processor, a configuration of a second sensing task from the SF;
performing, by the processor, the second sensing task based on the configuration of the second sensing task to obtain a second sensing result of the second sensing task; and
transmitting, by the processor, the second sensing result of the second sensing task to the SF.

18. The method of claim 17, further comprising:
receiving, by the processor, an indication of stopping the second sensing task from the SF; or
receiving, by the processor, an updated configuration of the second sensing task from the SF and performing the second sensing task based on the updated configuration of the second sensing task, wherein the updated configuration of the second sensing task is determined based on at least one of the configuration of the second sensing task and the second sensing result.

19. The method of claim 18, further comprising:
transmitting, by the processor, at least one of a sensing resource configuration and an updated sensing result of the second sensing task to the SF responsive to receiving the indication; and
stopping, by the processor, performing the second sensing task based on the indication.

20. An apparatus, operating as a sensing function (SF), comprising:
a transceiver which, during operation, wirelessly communicates with one or more candidate nodes; and
a processor communicatively coupled to the transceiver such that, during operation, the processor performs operations comprising:
selecting one or more first sensing nodes from the one or more candidate nodes to generate a first node list;
transmitting, via the transceiver, a configuration of a first sensing task to the one or more first sensing nodes;
receiving, via the transceiver, one or more first sensing results of the first sensing task from the one or more first sensing nodes; and
updating the first node list based on the one or more first sensing results.
